(19) United States
(12) Patent Application Publication
(10) Pub. No.: US 2025/0054492 A1
(43) Pub. Date: Feb. 13, 2025

(54) SPEECH RECOGNITION BASED ON BACKGROUND FEATURES

(71) Applicant: International Business Machines Corporation, Armonk, NY (US)

(72) Inventors: Yuan Jie Zhang, Ningbo (CN); Chao Yuan Huang, Taipei (TW); Yan Xiu Wu, Beijing (CN); Kevin Xin, Beijing (CN)

(73) Assignee: International Business Machines Corporation, Armonk, NY (US)

(21) Appl. No.: 18/231,164

(22) Filed: Aug. 7, 2023

(51) Int. Cl. G10L 15/06; G10L 15/00

(52) U.S. Cl. CPC G10L 15/063; G10L 15/005; G10L 2015/0635

(57) ABSTRACT

A method for improving the accuracy of speech recognition is disclosed. In one embodiment, such a method receives speech input from a user. The method further receives background inputs describing at least one of a webpage and an application from which the speech input was received. The method determines a language associated with the speech input and determines a weight and confidence level for each of the background inputs. A score is calculated for each of the background inputs based on the corresponding weight and confidence level. The method determines textual candidates for output in response to the speech input and ranks the textual candidates using a function that takes into account the scores and/or confidence levels of the background inputs. The textual candidate with the highest ranking may be returned to the user. A corresponding system and computer program product are also disclosed.

### BACKGROUND

### Field of the Invention

This invention relates generally to speech recognition and more particularly to systems methods for improving artificial intelligence (AI) speech recognition accuracy.

### Background of the Invention

The accuracy of artificial intelligence (AI) speech recognition holds significant importance in today's technological landscape. As voice-based interfaces become increasingly prevalent in our daily lives, accurate speech recognition ensures effective communication between humans and machines. When AI systems can precisely transcribe spoken words into text, it enhances user experiences by enabling seamless interactions with devices, virtual assistants, and applications. This accuracy simplifies tasks, such as setting reminders, sending messages, and retrieving information, empowering users with hands-free and intuitive control over technology. Moreover, in fields like healthcare and transcription services, high accuracy in speech recognition streamlines documentation processes, allowing professionals to focus more on their core tasks and improving overall productivity. The accessibility of AI speech recognition benefits individuals with disabilities, providing them with the means to effortlessly interact with computers and devices, fostering inclusivity and bridging communication barriers.

Beyond the individual level, the impact of speech recognition accuracy extends to businesses and industries. Companies may leverage this technology to streamline customer service operations by employing virtual assistants with accurate speech recognition capabilities. This leads to improved customer satisfaction as customers can articulate their needs naturally and receive precise responses without frustration. Furthermore, accurate speech recognition enables efficient data analysis and insights by converting spoken data, such as call center recordings or customer feedback, into textual information for analysis. Businesses can gain valuable insights from this data, leading to data-driven decisions that enhance product offerings and services. As AI speech recognition technology improves, its potential to enhance productivity and provide meaningful solutions to everyday challenges grows.

### SUMMARY

The invention has been developed in response to the present state of the art and, in particular, in response to the problems and needs in the art that have not yet been fully solved by currently available systems and methods. Accordingly, systems and methods have been developed to improve the accuracy of speech recognition technology. The features and advantages of the invention will become more fully apparent from the following description and appended claims, or may be learned by practice of the invention as set forth hereinafter.

Consistent with the foregoing, a method for improving the accuracy of speech recognition is disclosed. In one embodiment, such a method receives speech input from a user. The method further receives background inputs describing at least one of a webpage and an application from which the speech input was received. The method determines a language associated with the speech input and determines a weight and confidence level for each of the background inputs. A score is calculated for each of the background inputs based on the corresponding weight and confidence level. The method determines textual candidates for output in response to the speech input and ranks the textual candidates using a function that takes into account the scores and/or confidence levels of the background inputs. The textual candidate with the highest ranking may be returned to the user.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing a system for providing improved speech recognition based on background features;

FIG. 3 is a table showing various background features and methods for gathering information about the background features;

FIG. 4 is a table showing a specific example of background features that may be gathered for different users;

FIG. 5A is a table showing weighting of the background features;

FIG. 5B is a chart showing assignment of a confidence level to each of the background features;

FIG. 6 is a table showing a score calculated for each background feature;

FIG. 7 is a high-level block diagram showing how a language model may be selected based on the language code; and

FIG. 8 is a high-level block diagram showing how a ranking may be established for textual candidates based on the background features.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “speech recognition module 150”). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

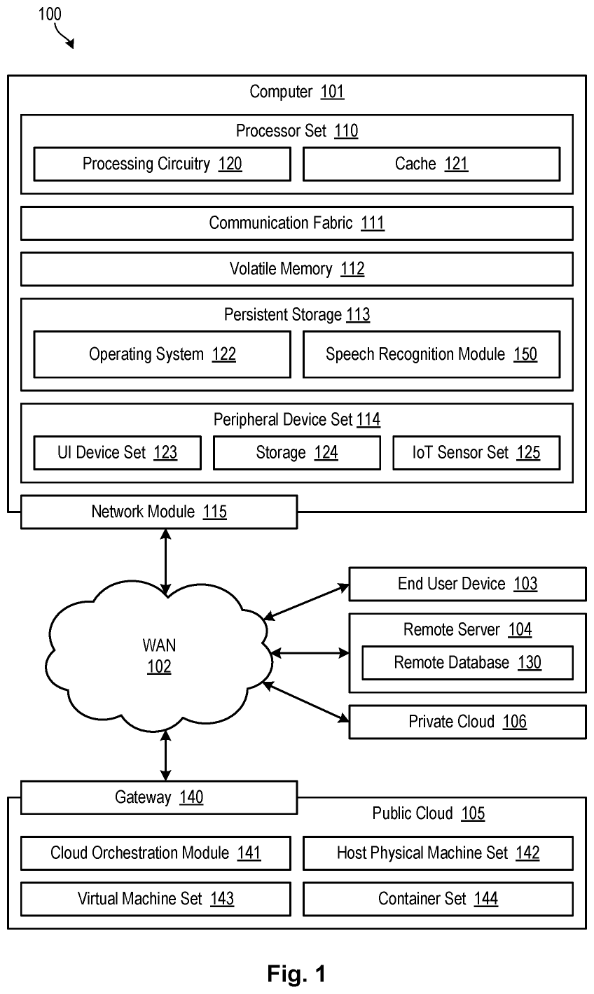

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

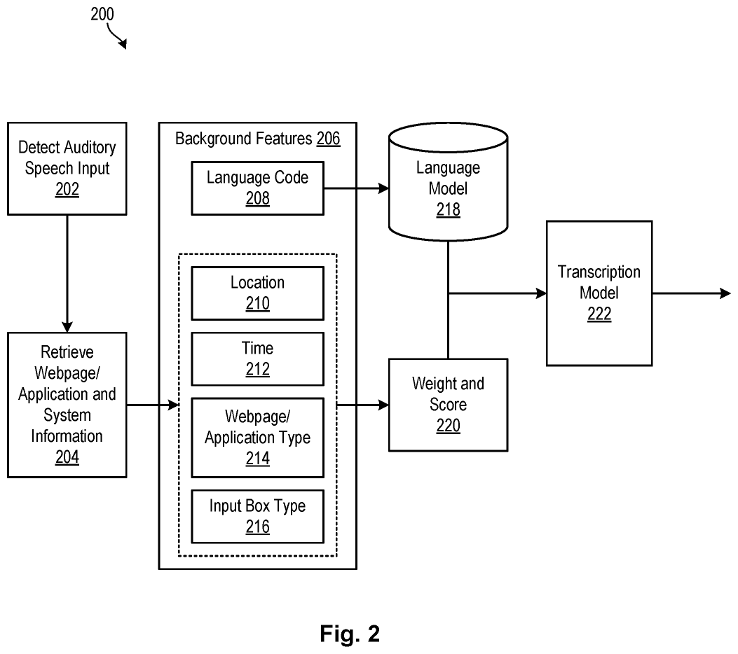

Referring to FIG. 2, as previously mentioned, accurate AI speech recognition is important to human-computer interaction, making it more natural and efficient. By enabling precise understanding and interpretation of spoken language, it empowers users to perform tasks hands-free and with greater ease. This has far-reaching implications for accessibility, allowing individuals with physical disabilities or limitations to engage with technology more effectively. Additionally, accurate speech recognition enhances productivity across industries, streamlining communication, facilitating transcription, and reducing administrative burdens. It opens up new possibilities in healthcare, education, and business settings, transforming the way people interact with technology and unlocking innovative applications for a more interconnected and efficient world. Thus, any technique that can improve the accuracy of speech recognition may have the ability to significantly improve the interaction between humans and computers.

Considering context when performing speech recognition may enable disambiguating spoken language, resolving homophones and homonyms, and comprehending incomplete sentences or speech. By considering surrounding information and situational cues, context enables the speech recognition system to choose the most appropriate interpretation of words or phrases with multiple meanings, ensuring precise transcription. Moreover, it may enable a system to adapt to user-specific language, real-world environments, and conversational flow, resulting in a more natural and seamless interaction with users. Without context, speech recognition may struggle to accurately understand spoken language, leading to increased errors and diminished usability in practical applications.

In certain embodiments, a speech recognition system 200 in accordance with the invention may be configured to consider various background features 206 (also referred to herein as “background inputs 206”) when performing speech recognition in order to improve its accuracy. The background features 206 may provide additional context for disambiguating spoken language, resolving homophones and homonyms, and/or comprehending incomplete sentences or speech.

As shown, a speech recognition system 200 in accordance with the invention may initially detect 202 auditory speech input 202. The speech recognition system 200 may also gather 204 information regarding a webpage, application, or other system that was used to gather the auditory speech input 202. Various background features 206 may be extracted based on the webpage, application, or system that is being used to receive the auditory speech input 202.

For example, in one embodiment, the background features 206 include one or more of a language code 208 that describes the language of the auditory speech input 202, a location 210 where the auditory speech input 202 was received, the time 212 that the auditory speech input 202 was received, the webpage and/or application type 214 from which the auditory speech input 202 was received, and the input box type 216 from which the auditory speech input 202 was received.

In certain embodiments, the language code 208 may be determined using an automated language detection functionality. In certain embodiments, this may be accomplished by analyzing acoustic features of the auditory speech input 202 and comparing these features against statistical language models for various languages. For example, it may break down the auditory speech input 202 into phonemes to identify unique phonetic patterns specific to different languages. By assigning probabilities to each language model based on acoustic characteristics, the language detection functionality may determine the language that is most likely being used. Contextual information, user preferences, and confidence thresholds may also be considered to enhance accuracy. Alternatively, the language code 208 may be retrieved from the current webpage and/or application from which the auditory speech input 202 is received.

Knowledge of the location 210 may increase the accuracy of speech recognition in that it may shed light on where the auditory speech input 202 was gathered and thus what topics or meanings the gathered words or phrases may have. The likelihood of certain words and/or phrases being used at one location may differ from those used at a different location. Similarly, knowing the time 212 that auditory speech input 202 was gathered may also shed light on what words or terms were used based on their temporal context. That is, the likelihood of certain words and/or phrases being used at a certain time of the day, week, month, year, etc. may differ from those likely to be used at other times. For example, the language used during a holiday or birthday may differ from the language used on normal days of the week.

Similarly, knowing the webpage and/or application type 214 that was used to receive the auditory speech input 202 may provide context for which words and/or phrases were used. For example if an application 214 is a texting application, certain words and/or phrases may be more likely to be used than if the application 214 is a search engine accessed through a web browser. For example, the auditory speech input 202 may be conversational in the texting application whereas the auditory speech input 202 may be requesting information in the search engine. Thus, the application that received the auditory speech input 202 may provide clues as to the words and/or phrases that were used.

Similarly, the type 216 of input box may also provide context on the words and/or phrases that were used. For example, if the auditory speech input 202 was received in a name input box associated with filling out a form, these words and/or phrases that were used may have different meaning than auditory speech input 202 that was received in association with responding to a text message or in the input box of a search engine. Thus, the input box type 216 may provide additional context or clues with respect to the words and/or phrases that are intended in the auditory speech input 202.

As shown in FIG. 2, the language code 208 previously discussed may be used to select a language model 218. This language model 218 may be used to convert phonetic output into words or sentences, and provide context, grammar, and word prediction to improve transcription accuracy in a particular language. As further shown in FIG. 2 and as will be discussed in more detail hereafter, in certain embodiments, the background features 206 and more particularly the location 210, time 212, webpage and/or application type 214, and input box type 216 may be weighted 220 and scored 220 to reflect how relevant the associated background features 206 are for particular auditory speech input 202 in determining the proper transcription.

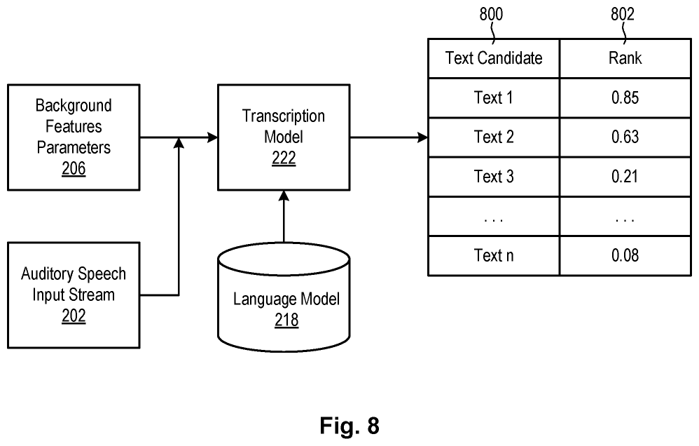

As further shown in FIG. 2, using the language model 218 and the weights 220 and scores 220, a transcription model 222 may transcribe the auditory speech input 202 to provide a ranked list of possible textual candidates. The textual candidate with the highest ranking may be the most likely to reflect what was intended in the auditory speech input 202, as will be explained in more detail in association with FIG. 8.

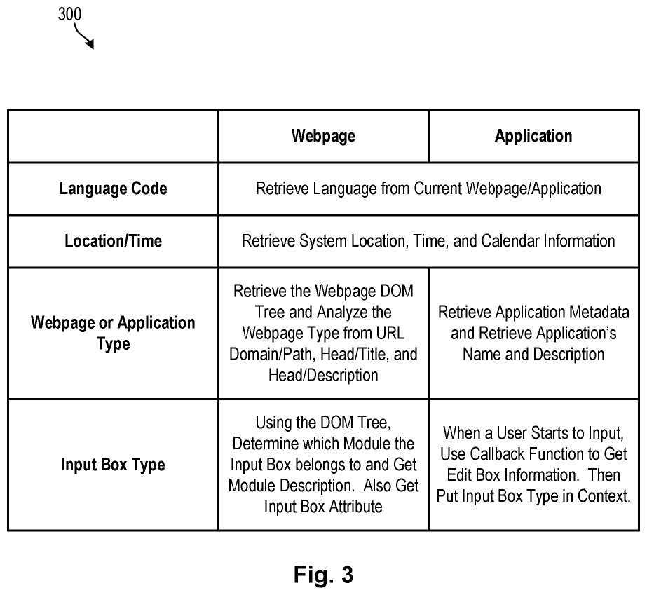

Referring to FIG. 3, a table 300 showing various background features 206 and methods for gathering information about the background features 206 is illustrated. More specifically, the table 300 describes how to retrieve the language code 208, location 210, time 212, webpage and/or application type 214, and input box type 216 for either a webpage or application, depending on which is being used to receive the auditory speech input 202.

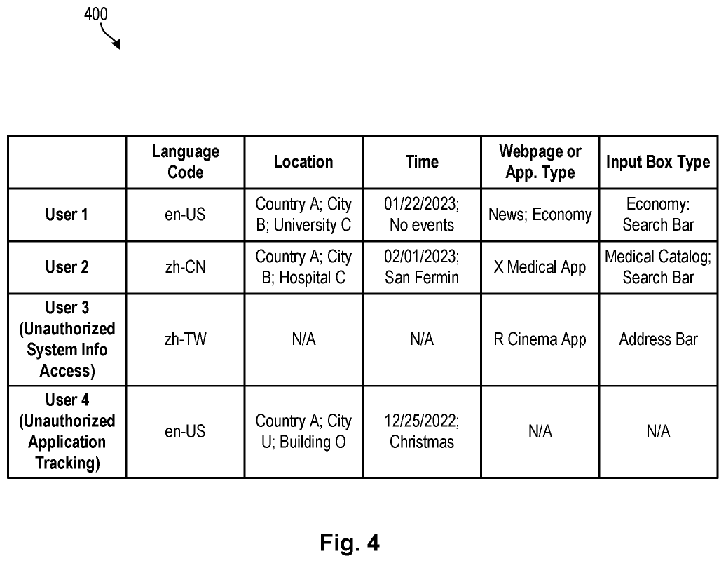

Referring to FIG. 4, a table 400 is presented showing an example of background features 206 that may be gathered for different users (i.e., User1-User4). More specifically, the table 400 shows the language code 208, location 210, time 212, webpage and/or application type 214, and input box type 216 for auditory speech input 202 gathered from the different users. As shown in FIG. 4, in some cases, certain background features 206 may not be retrievable. For example, if system access is not authorized as shown with respect to “User3”, background features 206 such as location 210 and/or time 212 may not be retrievable. Similarly, if application tracking is not authorized as shown with respect to “User4”, background features 206 such as webpage or application type 214 and/or input box type 216 may not be retrievable. In certain embodiments, systems and methods in accordance with the invention may be configured to still function where certain background features 206 are not retrievable.

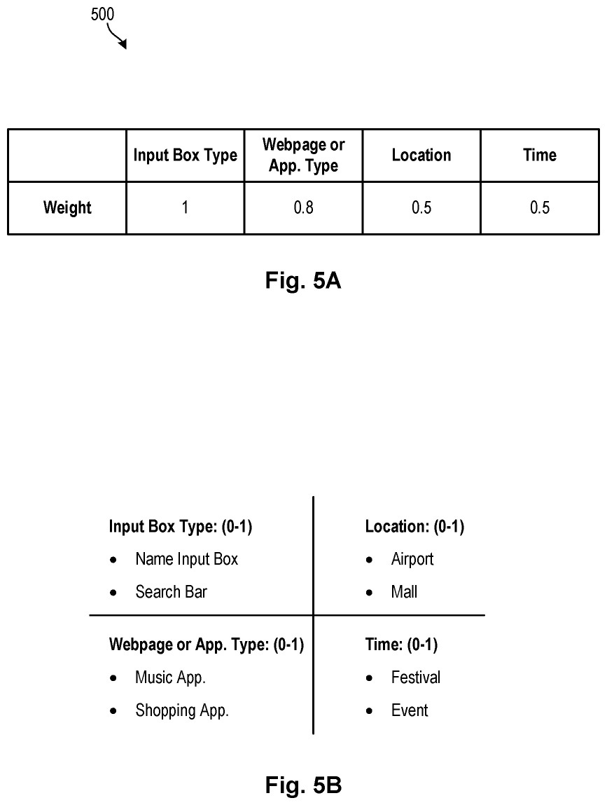

Referring to FIG. 5A, as previously mentioned, in certain embodiments, the background features 206 may be weighted to reflect how relevant the associated background features 206 are when predicting the correct textual output for particular auditory speech input 202. FIG. 5A is a table 500 showing exemplary weight values for each of the background features 206.

Referring to FIG. 5B, in certain embodiments, a confidence level may be established for each of the background features 206. The confidence level may reflect a degree of certainty or reliability that a particular background feature 206 has in correctly predicting the text output for particular auditory speech input 202. In certain embodiments, the confidence level may vary for different values of a background feature 206. For example, the confidence level may vary for different input box types 216 (e.g., a name input box versus a search bar) or for different locations 210 (e.g., an airport versus a mall) or for different application types 214 (e.g., a music application versus a shopping application), as shown in FIG. 5B

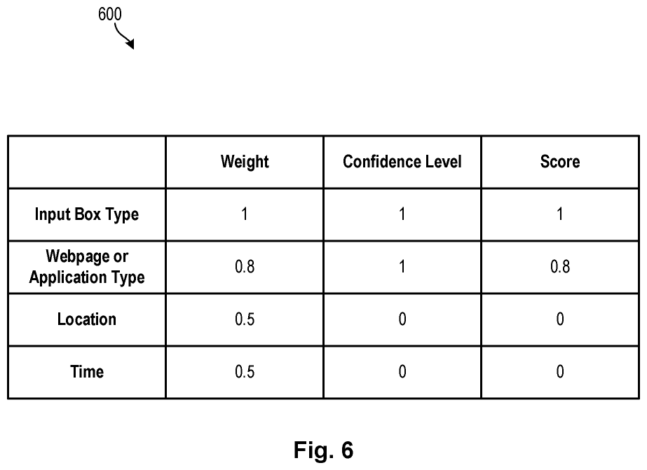

Referring to FIG. 6, using the weights and confidence levels discussed in association with FIGS. 5A and 5B, a score may be calculated for each of the background features 206. In certain embodiments, the score for a background feature 206 may be the product of the weight and confidence level for the background feature 206, as shown in the table 600 of FIG. 6.

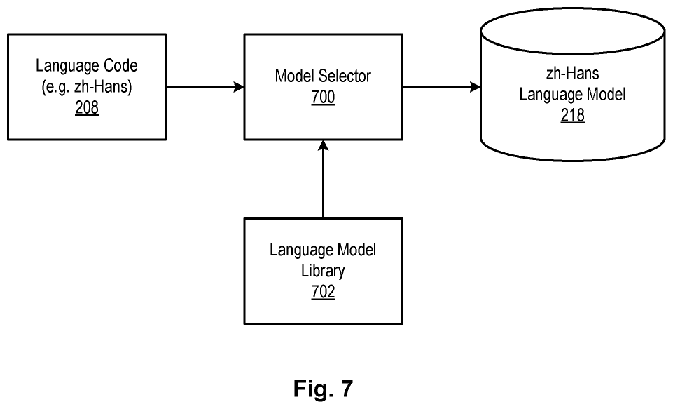

Referring to FIG. 7, as previously mentioned, the language code 208 previously discussed may be used to select a language model 218. For example, assume that the language code 208 is “zh-Hans”, which is the language tag used to identify the Chinese language written in Simplified Chinese script. This language code 208 may be provided to a model selector 700, which may select the “zh-Hans” language model 218 from a language model library 702. Other language models 218 may be selected for other language codes 208.

FIG. 8 is a high-level block diagram showing how a ranking may be established for various textual candidates 800 based on the background features 206. As shown in FIG. 8, using the background features 206, auditory speech input 202, and language model 218, the transcription model 222 may generate a ranked list of textual candidates 800 (i.e., Text 1-Text n). These textual candidates 800 (i.e., textual words, phrases, excerpts, etc.) may be ranked according to the likelihood that they accurately reflect what was intended in the auditory speech input 202. In certain embodiments, the ranking 802 may be established using a function that has as inputs one or more of the scores discussed in association with FIG. 6, the weights, and the confidence levels. In certain embodiments, the list of textual candidates 800 may be sorted in the order of ranking 802 and the textual candidate 800 with the highest ranking 802 (i.e., “Text 1” in the illustrated example) may be considered the most likely to be accurate (i.e., the best match). The transcription model 222 may output the best match or alternatively the entire list of textual candidates 800 and rankings 802 from which a user may select.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for improving the accuracy of speech recognition, the method comprising:
receiving speech input from a user;
receiving background inputs describing at least one of a webpage and an application from which the speech input was received;
determining a language associated with the speech input;
determining a weight and confidence level for each of the background inputs;
calculating a score for each of the background inputs based on the corresponding weight and confidence level;
determining a plurality of textual candidates for output in response to the speech input;
ranking the plurality of textual candidates using a function that takes into account the scores and the confidence levels of the background inputs; and
returning, to the user, the textual candidate with the highest ranking.

2. The method of claim 1, wherein determining the language comprises retrieving a language code from at least one of the webpage and the application.

3. The method of claim 1, wherein the background inputs further describe an input box from which the speech input was received.

4. The method of claim 1, wherein the background inputs further describe a time when the speech input was received.

5. The method of claim 1, wherein the background inputs further describe a location from which the speech input was received.

6. The method of claim 1, wherein calculating a score for a background input comprises multiplying the weight of the background input by the confidence level of the background input.

7. The method of claim 1, further comprising returning, to the user, the plurality of textual candidates and their rankings.

8. A computer program product for improving the accuracy of speech recognition, the computer program product comprising a computer-readable storage medium having computer-usable program code embodied therein, the computer-usable program code configured to perform the following when executed by at least one processor:
receive speech input from a user;
receive background inputs describing at least one of a webpage and an application from which the speech input was received;
determine a language associated with the speech input;
determine a weight and confidence level for each of the background inputs;
calculate a score for each of the background inputs based on the corresponding weight and confidence level;
determine a plurality of textual candidates for output in response to the speech input;
rank the plurality of textual candidates using a function that takes into account the scores and the confidence levels of the background inputs; and
return, to the user, the textual candidate with the highest ranking.

9. The computer program product of claim 8, wherein determining the language comprises retrieving a language code from at least one of the webpage and the application.

10. The computer program product of claim 8, wherein the background inputs further describe an input box from which the speech input was received.

11. The computer program product of claim 8, wherein the background inputs further describe a time when the speech input was received.

12. The computer program product of claim 8, wherein the background inputs further describe a location from which the speech input was received.

13. The computer program product of claim 8, wherein calculating a score for a background input comprises multiplying the weight of the background input by the confidence level of the background input.

14. The computer program product of claim 8, wherein the computer-usable program code is further configured to return, to the user, the plurality of textual candidates and their rankings.

15. A system for improving the accuracy of speech recognition, the system comprising:
at least one processor;
at least one memory device operably coupled to the at least one processor and storing instructions for execution on the at least one processor, the instructions causing the at least one processor to:
receive speech input from a user;
receive background inputs describing at least one of a webpage and an application from which the speech input was received;
determine a language associated with the speech input;
determine a weight and confidence level for each of the background inputs;
calculate a score for each of the background inputs based on the corresponding weight and confidence level;
determine a plurality of textual candidates for output in response to the speech input;
rank the plurality of textual candidates using a function that takes into account the scores and the confidence levels of the background inputs; and
return, to the user, the textual candidate with the highest ranking.

16. The system of claim 15, wherein determining the language comprises retrieving a language code from at least one of the webpage and the application.

17. The system of claim 15, wherein the background inputs further describe an input box from which the speech input was received.

18. The system of claim 15, wherein the background inputs further describe a time when the speech input was received.

19. The system of claim 15, wherein the background inputs further describe a location from which the speech input was received.

20. The system of claim 15, wherein the instructions further cause the at least one processor to return, to the user, the plurality of textual candidates and their rankings.
